(19) United States
(12) Patent Application Publication
(10) Pub. No.: US 2014/0335852 A1
(43) Pub. Date: Nov. 13, 2014

(54) CROSS-DEVICE NOTIFICATION APPARATUS AND METHOD

(71) Applicant: Wenlong Li, Beijing (CN)

(72) Inventor: Wenlong Li, Beijing (CN)

(21) Appl. No.: 13/993,669

(22) PCT Filed: Mar. 14, 2013
(86) PCT No.: PCT/CN13/72571

§ 371 Date: Jun. 12, 2013

(51) Int. Cl. H04W 68/02; H04M 1/725

(52) U.S. Cl. CPC H04W 68/025; H04M 1/72597; H04W 92/18
USPC 455/426.1

(57) ABSTRACT

Embodiments of apparatus and methods for cross device notification are described. A user may have multiple computing devices. In embodiments, a cross device notification server may receive a snapshot of a notification on one device associated with the user when the device is not in active use by the user. The cross device notification server may be further configured to provide the snapshot to another device that is in active use by the user. Other embodiments may be described and/or claimed.

### FIELD OF THE INVENTION

The present disclosure relates generally to microprocessor and memory apparatuses and methods, and more particularly, apparatuses and methods for cross device notification services.

### BACKGROUND

In modem life, a user may have multiple heterogeneous computing devices, and almost all of them provide at least one notification mechanism to inform the user of the occurrence of external or internal events, such as missed calls, new text messages, new email messages, available updates available for installed apps, battery status or warning, etc.

However, as the user is unlikely to simultaneously use all computing devices associated with the user, the user may miss the notification events on other devices that are not in active use. For example, when a user plays a game with a tablet after work, and the user's phone is placed away from the user, then the user may not only miss phone calls or short messages directed to the user's phone, but without actually receiving notifications of such missed calls or short messages.

### BRIEF DESCRIPTION OF THE DRAWINGS

Embodiments will be readily understood by the Wowing detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example cross device notification system, incorporating aspects of the present disclosure, in accordance with various embodiments.

FIG. 2 is a block diagram illustrating an example wireless device incorporating aspects of the present disclosure, in accordance with various embodiments.

FIG. 3 is a flow diagram of an example snapshot acquiring and sending process executable by an example apparatus, incorporating aspects of the present disclosure, in accordance with various embodiments.

FIG. 4 is a flow diagram of an example snapshot acquiring preparation process executable by an example apparatus, incorporating aspects of the present disclosure, in accordance with various embodiments.

FIG. 5 is a flow diagram of an example cross device notification process executable by an example apparatus, incorporating aspects of the present disclosure, in accordance with various embodiments.

FIG. 6 is a flow diagram of an example snapshot receiving and displaying process executable by an example apparatus, incorporating aspects of the present disclosure, in accordance with various embodiments.

FIG. 7 is a flow diagram of an example snapshot receiving preparation process executable by an example apparatus, incorporating aspects of the present disclosure, in accordance with various embodiments.

FIG. 8 illustrates an example computing device suitable for practicing the disclosed embodiments, in accordance with various embodiments.

FIG. 9 illustrates an article of manufacture having programming instructions, incorporating aspects of the present disclosure, in accordance with various embodiments.

### DETAILED DESCRIPTION

Embodiments of apparatus and methods for cross device notification are described herein. In embodiments, a user may have multiple computing devices, e.g., a computing tablet, a smartphone, and so forth. In embodiments, a cross device notification server may receive a snapshot of a notification on one device associated with the user, e.g., the smartphone, when the device is not in active use by the user. A snapshot may be a visual, auditory or other representation of the notification. The form of the snapshot may vary based on the nature of the original notification, the type of device receiving the original notification, the configurations of the cross device notification server, and the type of device expected to receive the snapshot, among many other factors. In embodiments, the snapshot may be a snapshot of text, image, audio, video or other types of information. The cross device notification server may be further configured to provide the snapshot to another device, e.g., the computing tablet that is in active use by the user thereby enhancing provision of notifications to a user. In embodiments, the snapshot may be reformatted to be presented to the user on an active device in a manner suitable to that device, or pre-selected by the user, to be more fully described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent, In particular, these operations may not be performed in the order of presentation. Operations described may be performed in a different order than the described embodiment. Various additional operations may be performed and/or described operations may be omitted in additional embodiments. For the purposes of the present disclosure, the phrase “A and/or B” means (A), (B), or (A and B), For the purposes of the present disclosure, the phrase “A, B, and/or C” means (A), (B), (C), (A and B), (A and C), (B and C), or (A, B and C). Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The description may use the phrases “in one embodiment,” “in an embodiment,” “in another embodiment,” “in embodiments,” “in various embodiments,” or the like, which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

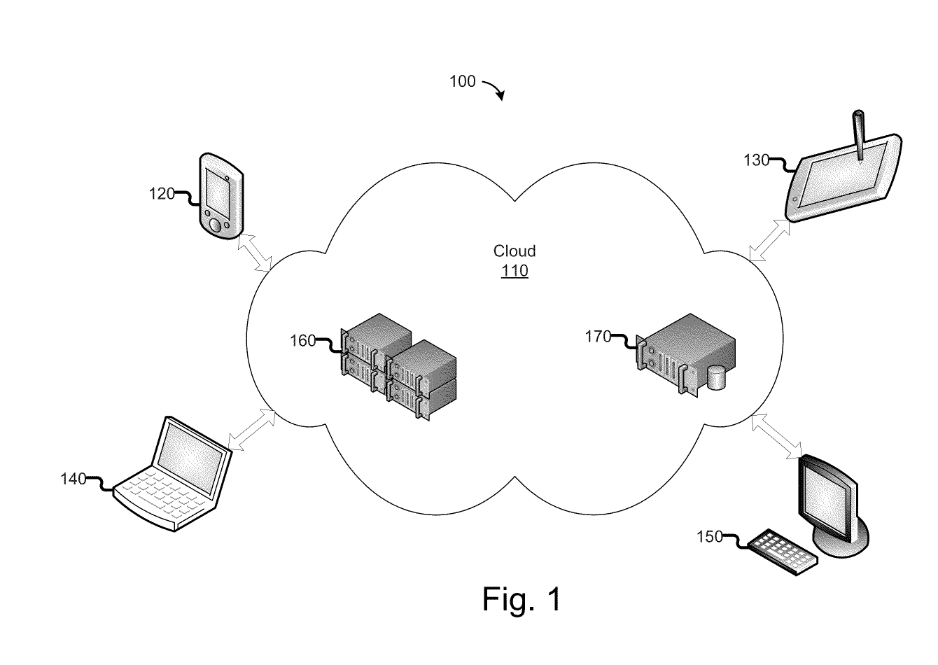

Referring now to FIG. 1, an example cross device notification system 100, in accordance with various embodiments, is illustrated. Cross device notification system 100 may include multiple server devices and user devices. As will be described in more detail below, server devices and user devices may be incorporated with the teachings of the present disclosure for cross device notification.

User devices in cross device notification system 100 may include heterogeneous computing devices such as a desktop computer 150, a laptop computer 140, a tablet computer 130, and a smartphone 120, incorporated with the teachings of the present disclosure. User devices in cross device notification system 100 may also include a handheld computer, a cellular phone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices, enhanced with the teachings of the present disclosure,

In embodiments, user devices in cross device notification system 100 may be configured to communicate with a computing infrastructure complex, or cloud 110. In embodiments, cloud 110 may include one or more server devices, for example, servers 160 and data servers 170, incorporated with the teachings of the present disclosure, to cooperatively provide cross device notification service. In embodiments, servers 160 may be application servers, sometimes also referred to as middleware, which may perform application related logic of cross device notification service between users and database servers 170. In embodiments, data servers 170 may be dedicated to provides database services for cross device notification service, and other computer programs or computers so that data may be queried, managed, stored, and retrieved from a storage.

Cloud 110 supports cloud computing which generally refers to an adequately resourced computing model with resources, such as hardware, storage, management solutions, security solutions, business applications, etc. available as services via networking. Cloud 110 may generally offer its services as infrastructure as a service (IaaS), platform as a service (PaaS), software as a service (SaaS), network as a service (NaaS), and communication as a service (CaaS). Moreover, cloud 110 may specifically offer cross device notification services (CDNS) based on one or more service types, such as IaaS, PaaS, SaaS, NaaS, or CaaS. In embodiments, CDNS may be provided by servers 160 in cooperation with data servers 170, hereinafter, collectively referred to as “cross device notification server”. Furthermore. the CONS may be made available on demand. and to be delivered economically.

In embodiments, CDNS may be configured to serve multiple devices associated with a user via a communication module. CDNS may be configured to register or associate the multiple devices with the user, for example, based on a common email address or user identification. CDNS may have cross device notification logic which may be configured to receive from a first device a snapshot of a notification on the first device when the first device is not in active use by the user, and subsequently, select a second device that is in active use by the user and provide the snapshot to the second device. Moreover, the snapshot may be stored and managed, for example, by data server 170 in connection with server 160, in the cloud 110. User devices may be wireless devices and thus may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate with cloud 110 via wireless links.

In embodiments, smartphone 120 may operate in accordance with suitable wireless communication protocols that require very low power such as Bluetooth®, ultra-wide band (UWB), and/or radio frequency identification (REID) to implement WPAN. In another example, tablet 130 may use direct sequence spread spectrum (DSSS) modulation and/or frequency hopping spread spectrum (FHSS) modulation to implement the WLAN (e.g., the 802.11 family of standards developed by the Institute of Electrical and Electronic Engineers (IEEE) and/or variations and evolutions of these standards).

In embodiments, laptop 140 may use OFDM modulation to transmit large amounts of digital data by splitting a radio frequency signal into multiple small sub-signals, which in turn, are transmitted simultaneously at different frequencies. In particular, laptop 140 may use OFDM modulation to implement WMAN. For example, laptop 140 may operate in accordance with the 802.16 family of standards developed by IEEE to provide for fixed, portable, and/or mobile broadband wireless access (BWA) networks (e.g., the IEEE std. 802.16-2004 (published Sep. 18, 2004), the IEEE std. 802.16e (published Feb. 28, 2006), or the IEEE std. 802.16f (published Dec. 1, 2005), etc. communicate with base stations via wireless link(s).

Although some of the above examples are described with respect to standards developed by IEEE, the present disclosure is readily applicable to many specifications and/or standards developed by other special interest groups and/or standard development organizations (e.g., Wireless Fidelity (Wi-fi) Alliance, Worldwide Interoperability for Microwave Access (WiMAX) Forum, Infrared Data Association (IrDA), or Third Generation Partnership Project (3GPP), etc.).

One or more wireless networks associated with user devices may be operatively coupled to a common public or private network such as the Internet, a telephone network (e.g., public switched telephone network (PSTN)), a local area network (LAN), a cable network and/or another wireless network via connection to an Ethernet, a digital subscriber line (DSL), a telephone line, a coaxial cable, and/or any wireless connection, etc.

Cross device notification system 100 may include other suitable wireless communication networks. For example, cross device notification system 100 may include a wireless wide area network (WWAN) (not shown). Cloud 110 may operate in accordance with other wireless communication protocols to support a WWAN. In particular, these wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced

Data GSM Environment (EDGE) technology, Universal Mobile Telecommunications System (UMTS) technology, Third Generation Partnership Project (3GPP) technology, standards based on these technologies, variations and evolutions of these standards, and/or other suitable wireless communication standards, Cross device notification system 100 may include various combinations of WPANs, WLANs, WMANs, and/or WWANs.

Cross device notification system 100 may include other WPAN, WLAN, WMAN, and/or WWAN devices (not shown) such as network interface devices and peripherals (e.g., network interface cards (NICs)), access points (APs), redistribution points, end points, gateways, bridges, hubs, etc to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system.

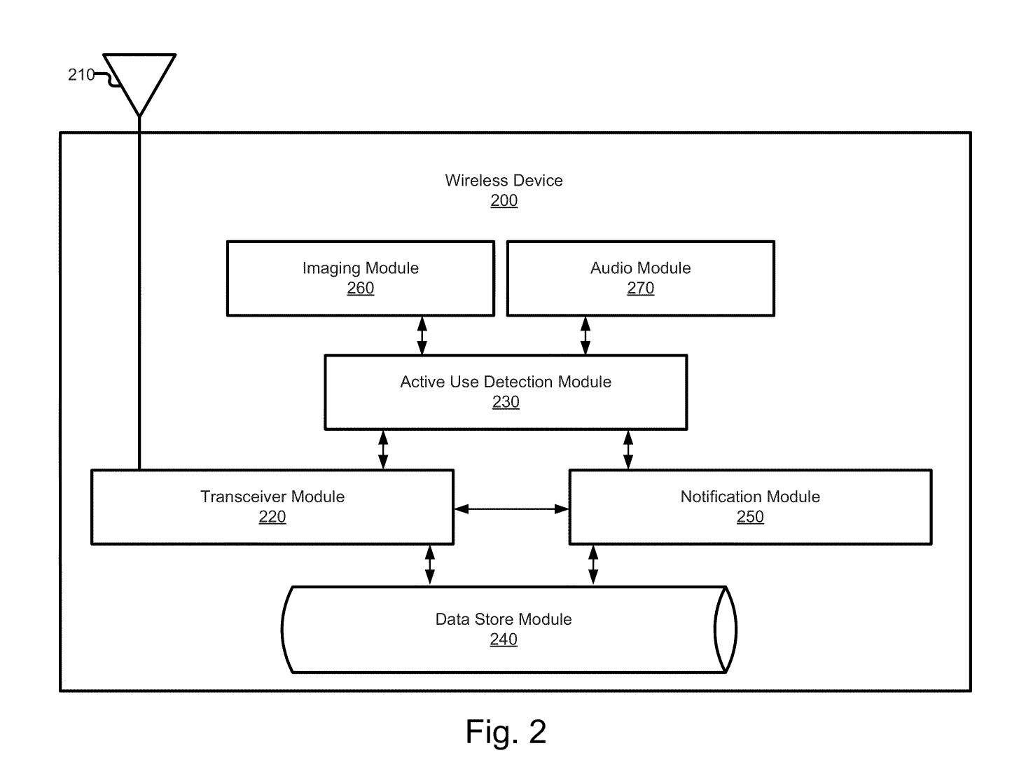

Referring now to FIG. 2, an example wireless device 200 is illustrated in further detail, in accordance with various embodiments. In some embodiments, wireless device 200 is a mobile wireless device, such as a PDA, cellular telephone, smartphone, tablet computer or laptop computer. The components of wireless device 200, discussed n detail below, may be included in any one or more of the devices discussed above with reference to FIG. 1, including smartphone 120, tablet computer 130, laptop computer 140, or any other suitable wireless devices.

Wireless device 200 may include antenna 210. Antenna 210 may include one or more directional or omni-directional antennas such as dipole antennas, monopole antennas, patch antennas, loop antennas, microstrip antennas, and/or other types of antennas suitable for reception of radio frequency (RF) or other wireless communication signals. Although FIG. 2 depicts a single antenna, wireless device 200 may include additional antennas.

Antenna 210 may be coupled to transceiver module 220. Transceiver module 220 may be configured to receive and transmit wireless signals from and to cloud 110 or any of the devices discussed above with reference to FIG. 1.

Transceiver module 220 may be configured to extract information from a wireless signal received, from other wireless devices. In some embodiments, this information may include information about voice communication, such as a voice call. In some embodiments, this information may include information about messaging communication, such as an incoming short message. In some embodiments, this information may include information about multimedia communication, such as a multimedia message. In some embodiments, this information may include information about data communication, such as an update for an existing app in the wireless device.

In some embodiments, such information may be wirelessly downloaded from a wireless information source to data store module 240. In some embodiments, such information may be retrieved remotely from a remote server in cloud 110. In sonic embodiments, such information may be retrieved directly from any of the devices discussed above with reference to FIG. 1. In some embodiments, such information may be dynamically learned from the environment surrounding wireless device 200, such as the strength of wireless signals or the status of wireless communication. The status of wireless communication may include information regarding network state, network utilization, networking speed, throughput, etc.

In some embodiments, such wireless communication may be event-driven when, for example, wireless device 200 switches to a new network, In some embodiments, such wireless communication may occur periodically. For example, wireless device 200 may be configured to communicate with a server in fixed time intervals. In some embodiments, such wireless communication may be initiated manually by a user when, for example, a user presses the sleep button and command wireless device 200 into an energy-saving mode, subsequently enable wireless device 200 to logout from a remote server.

Transceiver module 220 may be configured to pass relevant information to notification module 250. In embodiments, notification module 250 may be configured to receive information external events via transceiver module 220, but also internal events from wireless device 200. Consequently, notification module 250 may be configured to generate notification based at least in part on the received internal or external events. Subsequently, notification module 250 may be configured to display such notifications on wireless device 200. Additionally, notification module 250 may be configured to acquire a snapshot of such notifications. In embodiments, a notification may be a text message, a multimedia message, or an audible notification. In embodiments, a notification may be displayed on a pop-up window, a status bar, or the user interface of a notification application.

Wireless device 200 may further include active use detection module 230. In embodiments, active use detection module 230 may be coupled with and configured to communicate with transceiver module 220, notification module 250, imaging module 260, and audio module 270. In embodiments, active use detection module 230 may be configured to determine whether wireless device 200 is in active use by the user.

In embodiments, active use may refer to a device being actively used by the user, For example, tablet 130 may be actively used by the user for a video conference. In embodiments, active use may refer to the fact that a device being readily available to the user. For example, smartphone 120 may be placed in the vicinity of the user, and is readily available to the user. In embodiments, active use may refer to the fact that a device being frequently used by the user. Such device is relatively in “active use” comparing to other devices infrequently used by the user. In embodiments, active use may refer to the status of a device manually assigned by the user indicating user's preference to receive notification in such device.

In embodiments, active use detection module 230 may be configured to determine whether wireless device 200 is in active use by the user based on the information of user activities or system activities on real time, such as user input via an input device, networking activities, or system status. In embodiments, active use detection module 230 may also be configured to use information collected via imaging module 260 and audio module 270 to determine whether wireless device 200 is located in the vicinity of the user. In embodiments, active use detection module 230 may be configured to determine whether wireless device 200 is in active use based on historical usage of the device.

In embodiments, imaging module 260 may include a camera which may be used to record images that stored in data store module 240 or transmitted to another module, such as the active use detection module 230. In embodiments, these images may be still pictures or moving images such as videos. In embodiments, imaging module 260 may be configured for image recognition that is to identify a face or an object by comparing selected features from the image, such as facial features.

In embodiments, audio module 270 may include a digital audio recorder that records and plays back sounds, including articulated voices. In embodiments, audio module 270 may be sound-activated that may be automatically actuated upon detection of sound above a predetermined threshold. In embodiments, audio module 270 may be configured for speech recognition that is to recognize and/or transcribe what is being said, In embodiments, audio module 270 may be configured for speaker/voice recognition that is to identify the speaker by characteristics of their voice biometrics.

In embodiments, active use detection module 230 may also include one or more motion detection sensors (not shown), such as accelerometers, to detect direction and speed of movement of wireless device 200. Motion information may include velocity and acceleration information of wireless device 200. In embodiments, active use detection module 230 may utilize the motion information of wireless device 200 to selectively actuate imaging module 260 and/or audio module 270. Responding to commands from active use detection module 230, imaging module 260 and/or audio module 270 may perform various operations, such as to start, stop or pause image shooting or audio recording, or to perform operations on camera, such as operating a flash, altering a focus, and so forth. Information retrieved from imaging module 260 and/or audio module 270 may be used by active use detection module 230 to determine whether wireless device 200 is in active use by the user.

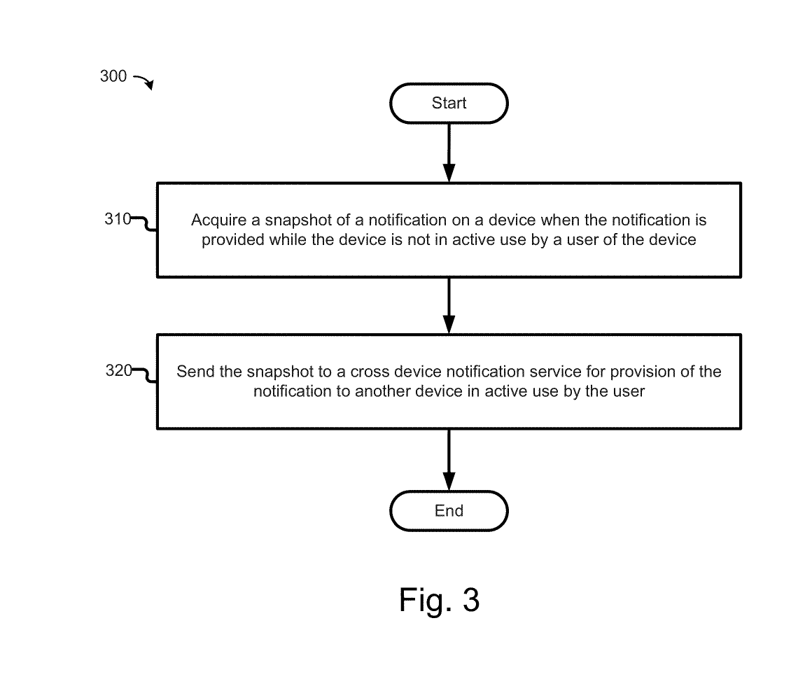

Referring now to FIG. 3, it is a flow diagram of an example snapshot acquiring and sending process executable by an example apparatus, incorporating aspects of the present disclosure, in accordance with various embodiments. As shown, process 300 may be performed by wireless device 200 to implement one or more embodiments of the present disclosure. In embodiments, the process may begin at block 310, where a snapshot may be acquired, by notification module 250, of a notification on a device when the notification is provided while the device is not in active use by a user of the device. Next, at block 320, the snapshot may be sent, e.g., by transceiver module 220, to a cross device notification service for provision of the notification to another device in active use by the user. In some embodiments, process 300 may then be repeated starting at block 310 for additional operational cycles, In some embodiments, process 300 may instead end.

In embodiments, the snapshot may be a snapshot of text, image, audio, or video. For example, a snapshot of a text message may be acquired as text, As another example, a snapshot may be acquired as an image of the notification panel/window on the device. Yet as another example, a snapshot may be acquired as an audio clip based on text to speech technology for visually challenged users. Yet as another example, a snapshot may be acquired as a video clip in order to capture a dynamically evolving event.

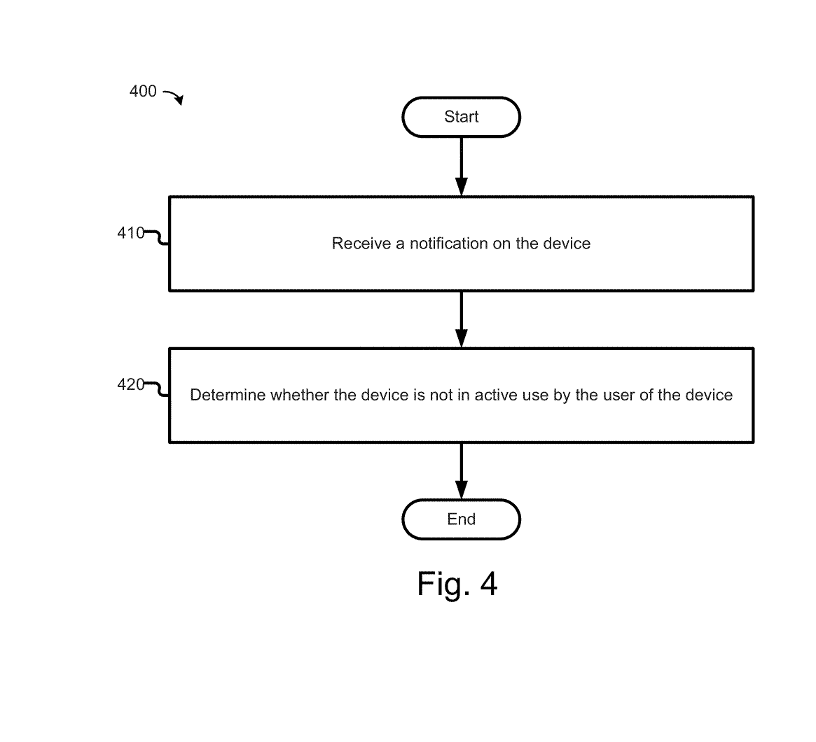

Referring now to FIG. 4, it is a flow diagram of an example snapshot acquiring preparation process executable by an example apparatus, incorporating aspects of the present disclosure, in accordance with various embodiments. As shown, process 400 may be performed by wireless device 200 to implement one or more embodiments of the present disclosure. In embodiments, process 400 may be performed prior to process 300 in connection with FIG. 3.

In embodiments, the process may begin at block 410, where a notification may be received on the device, e.g., by notification module 250, in cooperation with transceiver module 220 of a receiving device (see FIG. 2). A notification may be generated by notification module 250 of a sending device (see FIG. 2). Next, at block 420, it may be determined whether the device is not in active use by the user of the device. In embodiments, active use detection module 230 in FIG. 2 may make such determination. In sonic embodiments, process 400 may then be repeated starting at block 410 for additional operational cycles, In some embodiments, process 400 may instead end.

In embodiments, system information may be used in facilitating such determination that a device is not in active use by the user, for example, no CPU usage by user applications, lacking networking connections, etc. In embodiments, a predetermined event on the device may be used in facilitating such determination that a device is not in active use by the user. For example, long duration of lacking input from keyboard, mouse, or touchscreen may serve as a predetermined event to infer that the device is not in active use by the user. As another example, entering into an energy saving mode or starting a screensaver program may also serve as a predetermined event to infer that the device is not in active use by the user.

In embodiments, a visual recording of the surrounding of the device may be used. in facilitating such determination. For example, an image of a dark scene may indicate that the device is currently being stored away. As another example, the face profile of the user may be stored in the device. Similarly a predetermined landmark that generally associated with active use of a particular device by the user may also be stored in the device, However, if the face or the landmark found in the visual recording does not match with the face profile of the user or with the predetermined landmark respectively, then it may be inferred that the device is not in active use by the user.

In embodiments, an audio recording of the surrounding of the device may be used in facilitating such determination, for example, speaker recognition technology may be used in identifying whether the user is located in the vicinity of the device. In embodiments, either audio module 270 or active use detection module may be equipped. with such speaker recognition technology in connection with FIG. 2. The acoustic features of speech that recorded from the surrounding of the device may be used to compare with the voice biometrics or audio profile registered with the user. An audio profile may include features such as those acoustic patterns reflecting anatomy (e.g., size and shape of the throat and mouth) and learned behavioral patterns (e.g., voice pitch, speaking style) of a user. Subsequently, a non-match may be inferred as the device is not in active use by the user.

In embodiment, a determination indicating the device is not in active use by the user may be reported to a cross device notification service. Thus, the cross device notification service may not provide cross device notification to a device not in active use by the user.

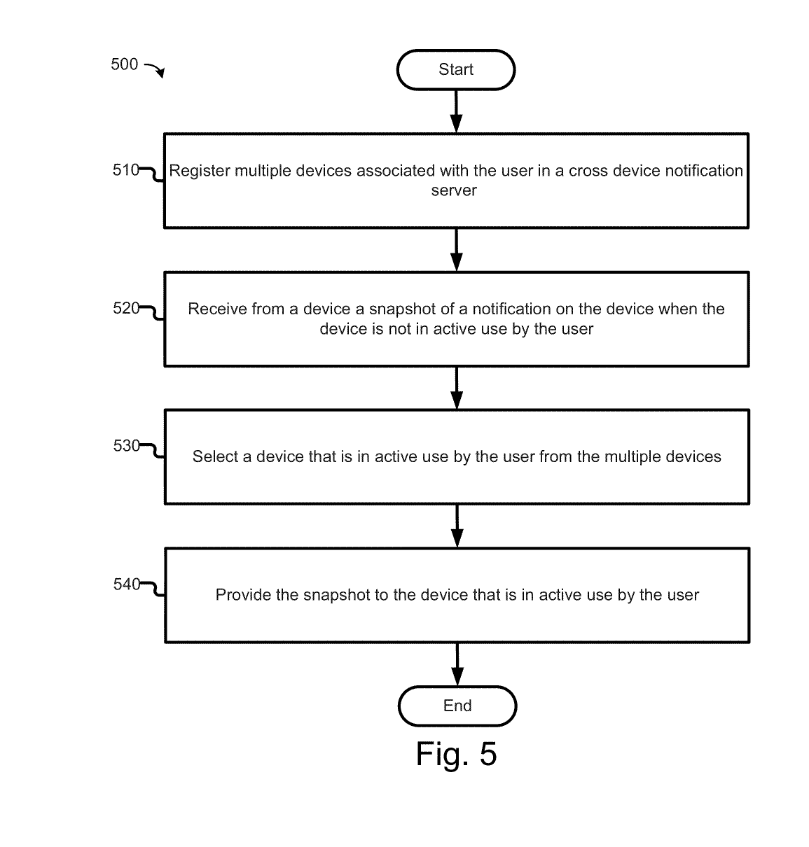

Referring Bow to FIG. 5, it is a flow diagram of an example cross device notification process executable by an example apparatus, incorporating aspects of the present disclosure, in accordance with various embodiments. As shown, process 500 may be performed by a remote server, for example, server 160, of cross device notification service on cloud 110 in FIG. 1 to implement one or more embodiments of the present disclosure. In embodiments, the process may begin at block 510, where multiple devices associated with the user may be registered in a cross device notification server, for example, server 160. Next, at block 520, a snapshot of one or more notifications on a registered device may be received, e.g., by server 160, when the device is not in active use by the user. Next, at block 530, another registered device may be selected, e.g., by server 160, among all registered devices if it is in active use by the user. Next, at block 540, the snapshot may be provided, e.g., by server 160, to the selected, device that is in active use by the user. In some embodiments, process 500 may then be repeated starting at block 510 for additional operational cycles. In some embodiments, process 500 may instead end.

In embodiments, the cross device notification service may be configured to associate multiple devices used by the user together through a registration process. For example, the registration process may be accomplished automatically by installing a cross device notification app which may be configured to authenticate the user before register the device. As another example, the registration process may be accomplished manually if the user chooses to provide a hardware identification of the device, such as Media Access Control (MAC) address to the cross device notification service, Yet as another example, a common identification, such as an email address of the user, may be used to bind multiple devices used, by the user in the cross device notification service so that these devices may be synchronized for their cross device notification services.

In embodiments, the multiple devices used by the user may run on heterogeneous operating systems (OS), for example, Android, BSD, iOS, Linux, Mac OS X, Microsoft Windows, and IBM z/OS. However, the cross device notification service may be configured to be OS-independent. Thus, the cross device notification service may be configured to receive the snapshot from one device running with Android, and provide the snapshot to another device running with iOS, or vice versa.

In embodiments, the snapshot may be stored in a storage location on cloud 110. For example, if no device is in active use by the user when the snapshot initially received by the cross device notification service, the snapshot may be stored and later provided to the first device used by the user. As another example, the cross device notification service may be implemented in either “pull” or “push” architecture, and provide the snapshot to any device entering into the state of active use. Yet as another example, the cross device notification service may only indicate to a device of the availability of a new snapshot of notification, and allow the device to have the autonomy to retrieve the new snapshot at a later time.

In embodiment, the cross device notification service may be configured to select one device from the multiple devices used by the user and provide the snapshot to that device. A device may periodically report its status regarding whether it is in active use to the cross device notification service. Alternatively the cross device notification service may randomly inquire such status from any device. If multiple devices may simultaneously indicate active use status, the cross device notification service may be configured to select only one or multiple devices to provide the snapshot based on its selection logic. For example, the selection logic may be based on the preference of the user. As another example, the selection logic may be determined by the statistical or historical usage of all devices by the user. Yet as another example, the selection logic may be derived from a global or default system setting.

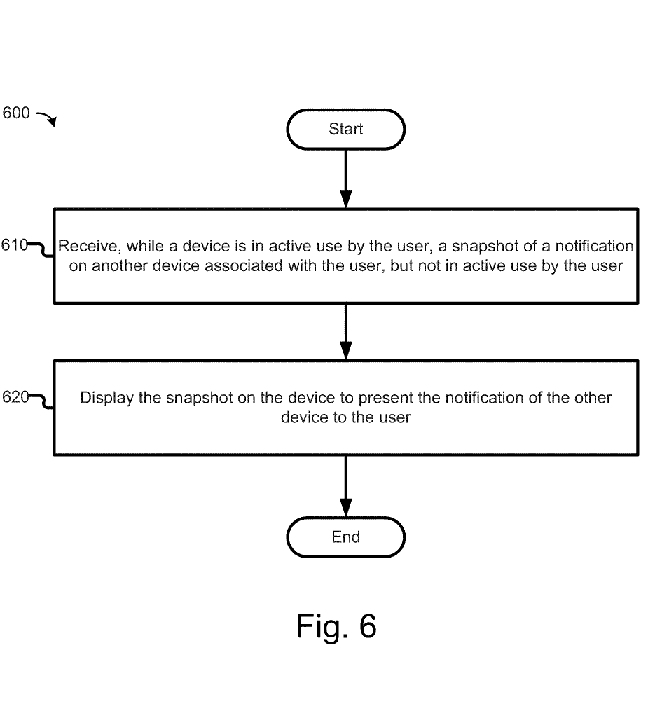

Referring now to FIG. 6, it is a flow diagram of an example snapshot receiving and displaying process executable by an example apparatus, incorporating aspects of the present disclosure, in accordance with various embodiments. As shown, process 600 may be performed by wireless device 200 to implement one or more embodiments of the present disclosure. In embodiments, the process may begin at block 610, where a snapshot may be received by a device, e.g., by transceiver module 220, while the device is in active use by the user, wherein the snapshot is based on a notification on another device associated with the user, but not in active use by the user. The snapshot may be provided by process 500 in connection with FIG. 5. Next, at block 620, the snapshot may be displayed on the device, e.g., by notification module 250, to present the notification of the other. device to the user. In some embodiments, process 600 may then be repeated starting at block 610 for additional operational cycles. In some embodiments, process 600 may instead end.

In some embodiments, the snapshot may be received via an electronic mail. In sonic embodiments, the snapshot may be received via a notification application or app installed on the device. In some embodiments, the snapshot may be received via a text message or a multimedia message. In some embodiments, the snapshot may be displayed as text or multimedia message. In some embodiments, the snapshot may be integrated into the existing notification panel or any existing notification mechanism. In some embodiments, the snapshot may be played if the snapshot is in audio or video format.

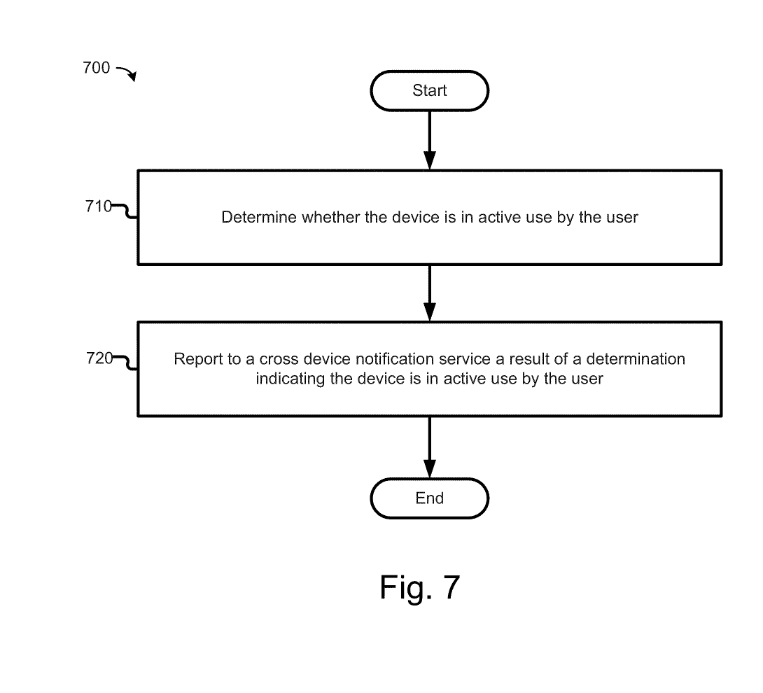

Referring now to FIG. 7, it is a flow diagram of an example snapshot receiving preparation process executable by an example apparatus, incorporating aspects of the present disclosure, in accordance with various embodiments. As shown, process 700 may be performed by wireless device 200 to implement one or more embodiments of the present disclosure. In embodiments, process 700 may be performed prior to process 600 in connection with FIG. 6.

In embodiments, the process may begin at block 710, where it may be determined whether the device is in active use by the user of the device. In embodiments, active use detection module 230 in FIG. 2 may be used in making such determination. Next, at block 720, the result of such determination may be reported to a cross device notification service, e.g., by notification module 250. In some embodiments, process 700 may then be repeated starting at block 710 for additional operational cycles. In some embodiments, process 700 may instead end.

In embodiments, the logic used in connection with block 420 in FIG. 4 may be similarly used in block 710 in determining whether the device is in active use by the user. In embodiments, once it is determined that the device is in active use, such determination may be reported to the cross device notification service. In embodiments, once it is determined that the device is in active use, the device may inquire the cross device notification service for potential unchecked snapshots of notifications from other devices associated with the user. In embodiments, once it is determined that the device is in active use, the device may directly inquire other peer devices for their snapshots of notifications via WiFi Direct, NFC, Bluetooth, etc., subsequently download those snapshots directly from those peers.

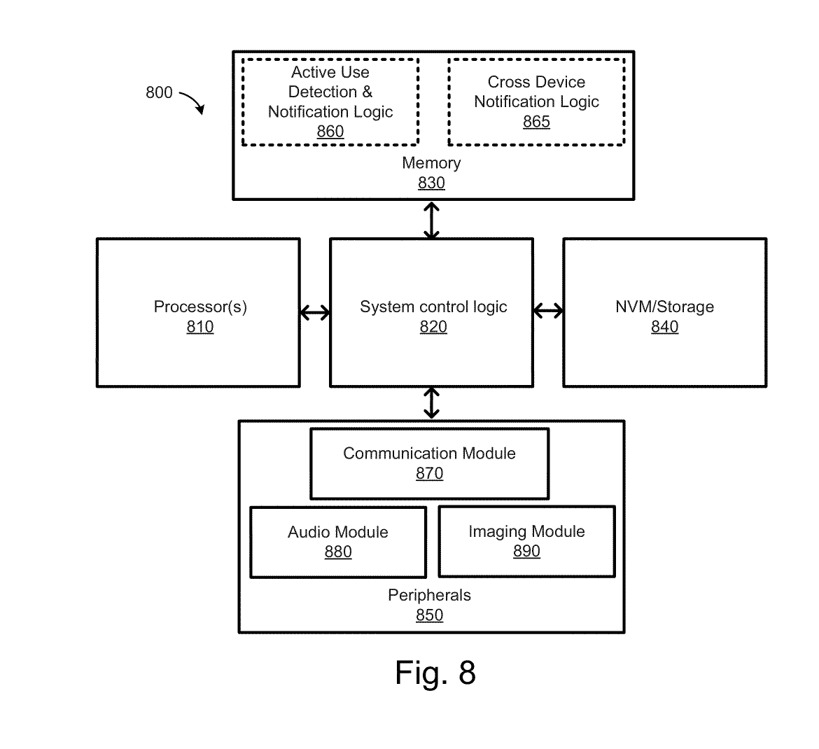

FIG. 8 illustrates an embodiment of a computing device 800 suitable for practicing embodiments of the present disclosure. As illustrated, computing device 800 may include system control logic 820 coupled to one or more processor(s) 810, to system memory 830, to non-volatile memory (NVM)/storage 840, and to one or more peripherals 850, in various embodiments, the one or more processors 810 may include a processor core. In embodiments, peripherals 850 may also include one or more communication modules, such as communication module 870. In embodiments, peripherals 850 may include audio module 880 and imaging module 890, similar to earlier described audio module 270 and imaging module 260 in connection with FIG. 2.

In some embodiments, system control logic 820 may include any suitable interface controllers to provide for any suitable interface to the processor(s) 810 and/or to any suitable device or component in communication with system control logic 820. System control logic 820 may also intemperate with a display (not shown) for display of information, such as to a user. In various embodiments, the display may include one of various display formats and forms, such as, for example, liquid-crystal displays, cathode-ray tube displays, and e-ink displays. In various embodiments, the display may include a touch screen.

In some embodiments, system control logic 820 may include one or more memory controller(s) (not shown) to provide an interface to system memory 830. System memory 830 may be used to load and store data and/or instructions, for example, for computing device 800. System memory 830 may include any suitable volatile memory, such as suitable dynamic random access memory (DRAM), for example.

In some embodiments, system control logic 820 may include one or more input/output (I/O) controller(s) (not shown) to provide an interface to NVM/storage 840 and peripherals 850. NVM/storage 840 may be used to store data and/or instructions, for example. NVM/storage 840 may include any suitable non-volatile memory, such as flash memory, for example, and/or may include any suitable non-volatile storage device(s), such as one or more hard disk drive(s) (HDD), one or more solid-state drive(s), one or more compact disc (CD) drive(s), and/or one or more digital versatile disc (DVD) drive(s), for example, NVM/storage 840 may include a storage resource that is physically part of a device on which computing device 800 is installed or it may be accessible by, but not necessarily a part of, computing device 800. For example, NVM/storage 840 may be accessed by computing device 800 over a network via one or more communication modules within peripherals 850.

In embodiments, system memory 830, NVM/storage 840, and system control logic 820 may include, in particular, temporal and persistent copies of active use detection and notification logic 860 and cross device notification logic 865. The active use detection and notification logic 860 may include instructions that, when executed by at least one of the processor(s) 810, result in computing device 800 practicing one or more aspects of cross device notification services, such as, but not limited to, operations performed by active use detection module 230 and/or notification module 250, described above. The cross device notification logic 865 may include instructions that, when executed by at least one of the processor(s) 810, result in computing device 800 practicing one or more aspects of cross device notification services, such as, but not limited to, operations performed by server 160 and/or data server 170, described above.

Communication module 870 within peripherals 850 may provide an interface for computing device 800 to communicate over one or more network(s) and/or with any other suitable device. Communications module 870 may include any suitable hardware and/or firmware, such as a network adapter, one or more antennas (such as antenna 210 of FIG. 2), wireless interface(s), and so forth. In various embodiments, communication module 870 may include an interface for computing device 800 to use NFC, optical communications (e.g., barcodes), or other similar technologies to communicate directly (e.g., without an intermediary) with another device. In various embodiments, communication module 870 may interoperate with radio communications technologies such as, for example, WCDMA, GSM, LTE, Bluetooth®, Zigbee, and the like.

Depending on which modules of wireless device 200 (FIG. 2) are hosted by computing device 800, the capabilities and/or performance characteristics of processors 810, memory 830, and so forth, may vary, In various embodiments, when used to host transceiver module 220 (FIG. 2), computing device 800 may include, but is not limited to, a smartphone, a computing tablet, an Ultrabook™, e-reader, a laptop computer, a desktop computer, a set-top box, a game console, or a server, In various embodiments, when used to host data store module 240 (FIG. 2), computing device 800 may be, but not limited to, one or more servers known in the art.

In some embodiments, at least one of the processor(s) 810 may be packaged. together with system control logic 820 and/or active use detection and notification logic 860. In some embodiments, at least one of the processor(s) 810 may be packaged together with system control logic 820 and/or active use detection and notification logic 860 to form a System in Package (SiP). In some embodiments, at least one of the processor(s) 810 may be integrated on the same die with system control logic 820 and/or active use detection and notification logic 860. In some embodiments, at least one of the processor(s) 810 may be integrated on the same die with system control logic 820 and/or active use detection and notification logic 860 to form a System on Chip (SoC).

In some embodiments, at least one of the processor(s) 810 may be packaged together with system control logic 820 and/or cross device notification logic 865. In some embodiments, at least one of the processor(s) 810 may be packaged together with system control logic 820 and/or cross device notification logic 865 to form a SiP. In some embodiments, at least one of the processor(s) 810 may be integrated on the same die with system control logic 820 and/or cross device notification logic 865. In some embodiments, at least one of the processor(s) 810 may be integrated on the same die with system control logic 820 and/or cross device notification logic 865 to form a SoC.

In various implementations, computing device 800 may be a laptop, a netbook, a notebook, an subnotebook, an Ultrabook™, a smartphone, a tablet, a personal digital assistant, an ultra mobile PC, a mobile phone, a desktop computer, a server, a printer, a scanner, a monitor, a set-top box, an entertainment control unit (e.g., a gaming console), a digital camera, a digital music player, or a digital video recorder. Additionally, other devices in the above-described interactions may be configured to perform various disclosed techniques.

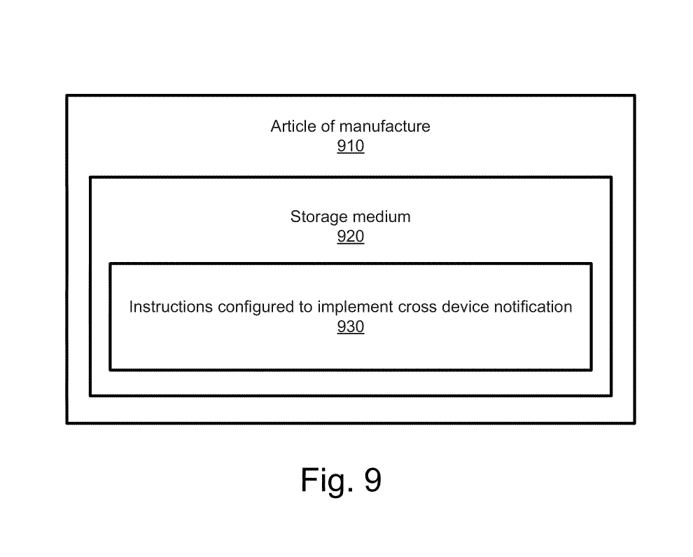

FIG. 9 illustrates an article of manufacture 910 having programming instructions, incorporating aspects of the present disclosure, in accordance with various embodiments. In various embodiments, an article of manufacture may be employed to implement various embodiments of the present disclosure. As shown, the article of manufacture 910 may include a computer-readable non-transitory storage medium 920 where instructions configured to implement cross device notification 930 reside. The storage medium 920 may represent a broad range of persistent storage medium known in the art, including but not limited to flash memory, dynamic random access memory, static random access memory, an optical disk, a magnetic disk, etc. Instructions 930 may enable an apparatus, in response to their execution by the apparatus, to perform various operations described herein. For example, storage medium 920 may include instructions 930 configured to cause an apparatus or system to practice some or all aspects of cross device notification of the process 300 of FIG. 3, process 400 of FIG. 4, process 500 of FIG. 5, or process 600 of FIG. 6, in accordance with embodiments of the present disclosure.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure, This application is intended to cover any adaptations or variations of the embodiments discussed herein. Therefore, it is manifestly intended that embodiments described herein be limited only by the claims.

The following paragraphs describe examples of various embodiments.

Example 1 is an apparatus for cross device notification which may include a communication module configured to communicate with multiple devices associated with a user, a processor coupled with the communication interface, and a cross device notification service configured to be operated by the processor to receive from a first device of the multiple devices a snapshot of a notification on the first device when the first device is not in active use by the user, and provide the snapshot to a second device of the plurality of devices that is in active use by the user.

Example 2 may include the subject matter of Example 1, and may further include a storage configured to store the snapshot before providing the snapshot to the second device.

Example 3 may include the subject matter of Examples 1-2, and further specifies that the cross device notification service may be configured to associate the multiple devices with the user.

Example 4 may include the subject matter of Examples 1-3, and farther specifics that the cross device notification service may be configured to receive the snapshot from the first device with the first device equipped with a first operating system, and provide the snapshot to the second device with the second device equipped with a second operating system that is different from the first operating system.

Example 5 may include the subject matter of Examples 1-4, and further specifies that the cross device notification service may be configured to select the second device from the multiple devices for providing the snapshot.

Example 6 may include the subject matter of Examples 1-5, and further specifies that the apparatus may be a server of a cloud computing environment,

Example 7 is one or more storage medium having stored therein a plurality of instructions configured to cause a device, in response to execution of the instructions by the device, to acquire a snapshot of a notification on the device when the notification is provided while the device is not in active use by a user of the device; and send the snapshot to a cross device notification service, operated by a server remotely disposed from the device, for provision of the notification to another device in active use by the user.

Example 8 includes the subject matter of example 7, and further specifies that the plurality of instructions may be configured to cause the device, in response to execution of the instructions by the device, to determine whether the device is not in active use by the user.

Example 9 includes the subject matter of example 7 or 8, and further specifies that the plurality of instructions may be configured to cause the device, in response to execution of the instructions by the device, to report to the cross device service a result of a determination indicating the device is not in active use by the user.

Example 10 includes the subject matter of example 8, and farther specifies that the determination may be based at least in part on a visual recording of a surrounding of the device.

Example 11 includes the subject matter of example 10, and further specifies that the visual recording may include a face or a landmark.

Example 12 includes the subject matter of example 11, and farther specifies that the determination may be based at least in part on a result of a comparison of the face with a face profile of the user or of the landmark with a predetermined landmark.

Example 13 includes the subject matter of example 8, and further specifies that the determination may be based at least in part on an audio recording of a surrounding of the device.

Example 14 includes the subject matter of example 13, and farther specifies that the determination may be based at least in part on a result of a comparison of the audio recording with an audio profile of the user.

Example 15 includes the subject matter of example 8, and further specifies that the determination may be based at least in part on an occurrence of a predetermined event on the device.

Example 16 includes the subject matter of example 15, and further specifies that the predetermined event may be generated from an input device.

Example 17 includes the subject matter of any one of Examples 7-16, and further specifies that the snapshot may be a snapshot of text, image, or video.

Example 18 is one or more storage medium having stored therein a plurality of instructions may be configured to cause a device associated with a user, in response to execution of the instructions by the device, to receive, from a cross device notification service operated by a server remotely disposed from the device, while the device is in active use by the user, a snapshot of a notification on another device associated with the user, but not in active use by the user; and display the snapshot on the device to present the notification of the other device to the user.

Example 19 includes the subject matter of example 18, and further specifies that the plurality of instructions may be further configured to cause the device, in response to execution of the instructions by the device, to determine whether the device is in active use by the user.

Example 20 includes the subject matter of example 19, and farther specifies that the plurality of instructions may be configured to cause the device, in response to execution of the instructions by the device, to report to the cross device notification service a result of a determination indicating the device is in active use by the user.

Example 21 includes the subject matter of example 19, and further specifies that the determination may be based at least in part on a visual recording of a surrounding of the device.

Example 22 includes the subject matter of example 21, and farther specifies that the visual recording may include a face or a landmark.

Example 23 includes the subject matter of example 22, and further specifies that the determination may be based at least in part on a result of a comparison of the face with a face profile of the user or of the landmark with a predetermined landmark.

Example 24 includes the subject matter of example 19, and further specifies that the determination may be based at least in part on an audio recording of a surrounding of the device.

Example 25 includes the subject matter of example 24, and further specifies that the determination may be based at least in part on a result of a comparison of the audio recording with a voice profile of the user.

Example 26 includes the subject matter of example 19, and further specifies that the determination may be based at least in part on an occurrence of a predetermined event on the device.

Example 27 includes the subject matter of example 26, and farther specifies that the predetermined event may be generated from an input device.

Example 28 includes the subject matter of any one of Examples 18-27, and further specifies that the snapshot may be a snapshot of text, image, or video.

Example 29 includes the subject matter of any one of Examples 18-28, and further specifies that receive may include receive the snapshot via an electronic mail.

Example 30 includes the subject matter of any one of Examples 18-28, and further specifies that receive may include receive the snapshot via a notification application.

Example 31 includes the subject matter of any one of Examples 18-28, and further specifies that receive may include receive the snapshot via a text message or a multimedia message.

Example 32 is method for cross device notification. The method may include receiving, by a cross device notification server, a snapshot of a notification on a first of a plurality of devices associated with a user, when the first device is not in active use by the user; and providing, by the cross device notification server, the snapshot to a second of the plurality of devices that is in active use by the user.

Example 33 includes the subject matter of example 32, and may further include storing the snapshot in an external storage outside of the first device before providing the snapshot to the second device.

Example 34 includes the subject matter of example 32 or 33, and may further include associating the plurality of devices with the user,

Example 35 includes the subject matter of any one of Examples 32-34, and may further include selecting the second device from the plurality of devices for providing the snapshot.

Example 36 is a device for cross device notification which may include a notification module configured to acquire a snapshot of a notification on the device when the notification is provided while the device is not in active use by a user of the device; and a transceiver module coupled with the notification module and configured to send the snapshot to a cross device notification service, operated by a server remotely disposed from the device, for provision of the notification to another device in active use by the user.

Example 37 includes the subject matter of example 36, may further include a detection module coupled with the notification module and configured to determine whether the device is not in active use by the user.

Example 38 includes the subject matter of example 36 or 37, and further specifies that the notification module may be configured to report to the cross device service a result of a determination indicating the device is not in active use by the user.

Example 39 includes the subject matter of example 37, and further specifies that the detection module may be configured to determine based at least in part on a visual recording of a surrounding of the device.

Example 40 includes the subject matter of example 39, and farther specifies that the visual recording may include a face or a landmark.

Example 41 includes the subject matter of example 40, and further specifies that the detection module may be configured to determine based at least in part on a result of a comparison of the face with a face profile of the user or of the landmark with a predetermined landmark.

Example 42 includes the subject matter of example 37, and further specifies that the detection module may be configured to determine based at least in part on an audio recording of a surrounding of the device.

Example 43 includes the subject matter of example 42, and further specifies that the detection module may be configured to determine based at least in part on a result of a comparison of the audio recording with an audio profile of the user.

Example 44 includes the subject matter of example 37, and farther specifies that the detection module may be configured to determine based at least in part on an occurrence of a predetermined event on the device.

Example 45 includes the subject matter of example 44. and further specifies that the predetermined event may be generated from an input device.

Example 46 includes the subject matter of any one of Examples 36-45, and further specifies that the snapshot may be a snapshot of text, image, or video.

Example 47 is a device for cross device notification which may include a transceiver module configured to receive, from a cross device notification service operated by a server remotely disposed from the device, while the device is in active use by the user, a snapshot of a notification on another device associated with the user, but not in active use by the user; and a notification module coupled with the transceiver module, and configured to display the snapshot on the device to present the notification of the other device to the user.

Example 48 includes the subject matter of example 47, may further include a detection module coupled with the notification module, and configured to determine whether the device is in active use by the user,

Example 49 includes the subject matter of example 47. and further specifies that the notification module may be further configured to report to the cross device notification service a result of a determination indicating the device is in active use by the user.

Example 50 includes the subject matter of example 48, and farther specifies that the detection module may be configured to determine based at least in part on a visual recording of a surrounding of the device.

Example 51 includes the subject matter of example 50, and further specifies that the visual recording may include a face or a landmark.

Example 52 includes the subject matter of example 51, and further specifies that the detection module may be configured to determine based at least in part on a result of a comparison of the face with a face profile of the user or of the landmark with a predetermined landmark.

Example 53 includes the subject matter of example 48, and further specifies that the detection module may be configured to determine based at least in part on an audio recording of a surrounding of the device.

Example 54 includes the subject matter of example 53, and farther specifies that the detection module may be configured to determine based at least in part on a result of a comparison of the audio recording with a voice profile of the user.

Example 55 includes the subject matter of example 48, and further specifies that the detection module may be configured to determine based at least in part on an occurrence of a predetermined event on the device.

Example 56 includes the subject matter of example 55, and farther specifies that the predetermined event may be generated from an input device.

Example 57 includes the subject matter of any one of Examples 47-56, and further specifies that the snapshot may be a snapshot of text, image, or video.

Example 58 includes the subject matter of any one of Examples 47-57, and further specifies that the transceiver module may be configured to receive the snapshot via an electronic mail.

Example 59 includes the subject matter of any one of Examples 47-57, and further specifies that the transceiver module may be configured to receive the snapshot via a notification application.

Example 60 includes the subject matter of any one of Examples 47-57, and further specifies that the transceiver module may be configured. to receive the snapshot via a text message or a multimedia message.

Example 61 is a device for cross device notification which may include means for acquiring a snapshot of a notification on the device when the notification is provided while the device is not in active use by a user of the device; and means for sending the snapshot to across device notification service, operated by a server remotely disposed from the device, for provision of the notification to another device in active use by the user.

Example 62 may include the subject matter of Example 61, and may further include means for determining whether the device is not in active use by the user.

Example 63 may include the subject matter of Example 61, and may further include means for reporting to the cross device service a result of a determination indicating the device is not in active use by the user.

Example 64 includes the subject matter of Example 62, and further specifies that the means for determining may include means for determining based at least in part on a visual recording of a surrounding of the device.

Example 65 includes the subject matter of Example 62, and further specifies that the visual recording may include a face or a landmark.

Example 66 includes the subject matter of Example 65, and further specifies that the means for determining may include means for determining based at least in part on a result of a comparison of the face with a face profile of the user or of the landmark with a predetermined landmark.

Example 67 includes the subject matter of Example 62, and further specifies that the means for determining may include means for determining based at least in part on an audio recording of a surrounding of the device.

Example 68 includes the subject matter of Example 67, and further specifies that the means for determining may include means for determining based at least in part on a result of a comparison of the audio recording with an audio profile of the user.

Example 69 includes the subject matter of Example 62, and further specifies that the means for determining may include means for determining based at least in part on an occurrence of a predetermined event on the device.

Example 70 includes the subject matter of Example 69, and further specifies that the predetermined event is generated from an input device.

Example 71 includes the subject matter of any one of Examples 61-70, and further specifies that the snapshot may be a snapshot of text, image, or video.

Example 72 is a device for cross device notification which may include means for receiving, from a cross device notification service operated by a server remotely disposed from the device, while the device is in active use by the user, a snapshot of a notification on another device associated with the user, but not in active use by the user; and means for displaying the snapshot on the device to present the notification of the other device to the user.

Example 73 may include the subject matter of Example 72, and may further include means for determining whether the device is in active use by the user.

Example 74 may include the subject matter of Example 72, and may further include means for reporting to the cross device notification service a result of a determination indicating the device is in active use by the user.

Example 75 includes the subject matter of Example 73, and further specifies that the means for determining may include means for determining based at least in part on a visual recording of a surrounding of the device.

Example 76 includes the subject matter of Example75, and further specifies that the visual recording may include a face or a landmark.

Example 77 includes the subject matter of Example 76, and further specifies that the means for determining may include means for determining based at least in part on a result of a comparison of the face with a face profile of the user or of the landmark with a predetermined landmark.

Example 78 includes the subject matter of Example 73, and further specifies that the means for determining may include means for determining based at least in part on an audio recording of a surrounding of the device.

Example 79 includes the subject matter of Example 78, and further specifies that the means for determining may include means for determining based at least in part on a result of a comparison of the audio recording with a voice profile of the user.

Example 80 includes the subject matter of Example 73, and further specifies that the means for determining may include means for determining based at least in part on an occurrence of a predetermined event on the device.

Example 81 includes the subject matter of Example 80, and further specifies that the predetermined event is generated from an input device.

Example 82 includes the subject matter of any one of Examples 72-81, and further specifies that the snapshot is a snapshot of text, image, or video.

Example 83 includes the subject matter of any one of Examples 72-82, and further specifies that the means for receiving may include means for receiving the snapshot via an electronic mail.

Example 84 includes the subject matter of any one of Examples 72-82, and further specifies that the means for receiving may include means for receiving the snapshot via a notification application.

Example 85 includes the subject matter of any one of Examples 72-82, and further specifies that the means for receiving may include means for receiving the snapshot via a text message or a multimedia message.

1. An apparatus comprising:
a communication module configured to communicate with a plurality of devices associated with a user;
a processor coupled with the communication module; and
a cross device notification logic configured to be operated by the processor to receive from a first device of the plurality of devices a snapshot of a notification on the first device when the first device is not in active use by the user, and provide the snapshot to a second device of the plurality of devices that is in active use by the user.

2. The apparatus according to claim 1, wherein the cross device notification logic is configured to associate the plurality of devices with the user.

3. The apparatus according to claim 1, wherein the cross device notification logic is configured receiving the snapshot from the first device with the first device equipped with a first operating system, and provide the snapshot to the second device with the second device equipped with a second operating system that is different from the first operating system.

4. The apparatus according to claim 1, wherein the cross device notification logic is configured to select the second device from the plurality of devices for providing the snapshot.

5. The apparatus according to claim 1, wherein the apparatus is a server of a cloud computing environment.

6. A method, comprising:
receiving, by a cross device notification server, a snapshot of a notification on a first of a plurality of devices associated with a user, when the first device is not in active use by the user; and
providing, by the cross device notification server, the snapshot to a second of the plurality of devices that is in active use by the user.

7. The method according to claim 6, further comprising:
storing the snapshot in an external storage outside of the first device before providing the snapshot to the second device.

8. The method according to claim 6, further comprising:
selecting the second device from the plurality of devices for providing the snapshot.

9. A device, comprising:
a notification module configured to acquire a snapshot of a notification on the device when the notification is provided while the device is not in active use by a user of the device; and
a transceiver module coupled with the notification module, and configured to send the snapshot to a cross device notification service, operated by a server remotely disposed from the device, for provision of the notification to another device in active use by the user.

10. The device according to claim 9, wherein the snapshot is a snapshot of text, image, or video.

11. The device according to claim 9, further comprising:
a detection module coupled with the notification module, and configured to determine whether the device is not in active use by the user.

12. The device according to claim 11, wherein the detection module is configured to determine based at least in part on a visual recording of a surrounding of the device.

13. The device according to claim 12, wherein the visual recording comprises a face or a landmark, and wherein determine comprises determine based at least in part on a result of a comparison of the face with a face profile of the user or of the landmark with a predetermined landmark.

14. The device according to claim 11, wherein the detection module is configured to determine based at least in part on an audio recording of a surrounding of the device.

15. The device according to claim 14, wherein the detection module is configured to determine based at least in part on a result of a comparison of the audio recording with an audio profile of the user.

16. A device for cross device notification, comprising:
a transceiver module configured to receive, from a cross device notification service operated by a server remotely disposed from the device, while the device is in active use by the user, a snapshot of a notification on another device associated with the user, but not in active use by the user; and
a notification module coupled with the transceiver module and configured to display the snapshot on the device to present the notification of the other device to the user.

17. The device according to claim 16, wherein the transceiver module is configured to receive the snapshot via a select one of an electronic mail, a notification application, a text message, or a multimedia message.

18. The device according to claim 16, further comprising:
a detection module configured to determine whether the device is in active use by the user.

19. The device according to claim 18, wherein the notification module is further configured to:
report to the cross device notification service a result of a determination indicating the device is in active use by the user.

20. The device according to claim 18, wherein the detection module is configured to determine based at least in part on a visual recording of a surrounding of the device.

21. The device according to claim 20, wherein the visual recording comprises a face or a landmark, and wherein determine comprises determine based at least in part on a result of a comparison of the face with a face profile of the user or of the landmark with a predetermined landmark.

22. The device according to claim 18, wherein the detection module is configured to determine based at least in part on an audio recording of a surrounding of the device.

23. The device according to claim 22, wherein the detection module is configured to determine based at least in part on a result of a comparison of the audio recording with a voice profile of the user.

24. The device according to claim 18, wherein the detection module is configured to determine based at least in part on an occurrence of a predetermined event on the device generated from an input device.
